(19) United States
(12) Patent Application Publication
(10) Pub. No.: US 2024/0134365 A1
(43) Pub. Date: Apr. 25, 2024

(54) PROACTIVE MITIGATION OF POTENTIAL OBJECT STATE DEGRADATION

(71) Applicant: Intel Corporation, Santa Clara, CA (US)

(72) Inventors: Fabian Oboril, Karlsruhe (DE); Cornelius Buerkle, Karlsruhe (DE); Priyanka Mudgal, Portland, OR (US); Frederik Pasch, Karlsruhe (DE); Syed Qutub, Munich (DE); Kay-Ulrich Scholl, Malsch (DE)

(21) Appl. No.: 18/395,849

(22) Filed: Dec. 26, 2023

(51) Int. Cl. G05B 19/418; G05D 1/698; G05D 107/70

(52) U.S. Cl. CPC G05B 19/41895; G05D 1/698; G05D 2107/70

(57) ABSTRACT

A system, including: a communication interface operable to receive sensor data related to a state of an object; object state estimation processor circuitry operable to estimate, based on the sensor data, a prospective probability of a degradation of the state of the object; and cobot fleet control processor circuitry operable to generate a command for either a transport cobot operable to transport the object, or another actor, to take proactive action to mitigate the prospective probability of the degradation of the state of the object.

### BACKGROUND

In warehouses and logistics facilities, objects are continuously moved by mobile robots or cobots (collaborative robots), pick-and-place cobots, and/or humans. During these movements, there is a risk that objects will be damaged or misplaced, or parts of transported objects will fall. Unfortunately, these problems often go undetected, ultimately resulting in a customer receiving a defective shipment or, in some cases, a lost shipment.

### BRIEF DESCRIPTION OF THE FIGURES

FIG. 1 illustrates a schematic diagram of a system for proactive mitigation of potential object state degradation, in accordance with aspects of the disclosure.

FIG. 2 illustrates a schematic diagram of a monitoring and control system, in accordance with aspects of the disclosure.

FIG. 3 illustrates a flow diagram of object state degradation and robot fleet control, in accordance with aspects of the disclosure.

FIG. 4 illustrates a block diagram of a computing device, in accordance with aspects of the disclosure.

### DETAILED DESCRIPTION

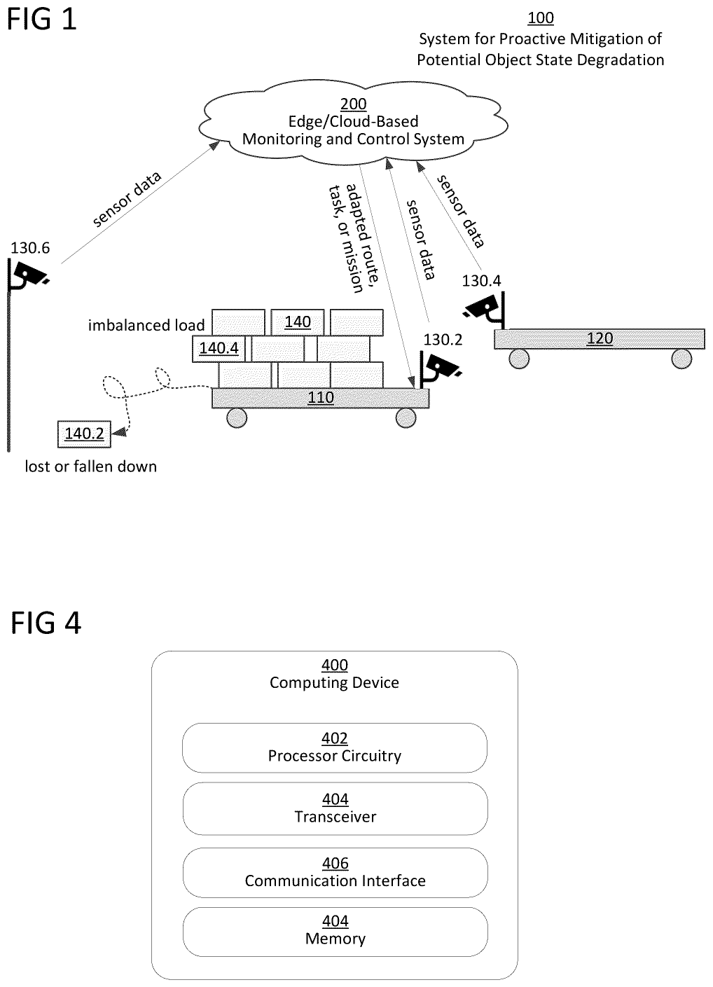

FIG. 1 illustrates a schematic diagram of a system 100 for proactive mitigation of potential object state degradation, in accordance with aspects of the disclosure.

The system 100 addresses the warehouse challenges described above by monitoring the states of objects 140 (140, 104.2, 104.4). System 100 uses sensors 130 (10.2, 130.4, 103.6) of a transport cobot 110, other cobots 120, and/or those available within the infrastructure to continuously sense the current states of objects 140 moving within a warehouse or fulfillment facility. The sensors 130 are operable to detect and track the objects and output sensor data related to the states of an objects 104 and other elements in the environment. The sensors 130 may be stationary (mounted on walls, shelves, poles) or mobile. The sensors 130 can be cameras and/or other sensors, such as thermal sensors or LIDAR sensors. Mobile sensors may be mounted, for example, on cobots 110, 120, or on any other mobile device.

The sensor data is transmitted via a communication interface to a monitoring and control system 200, which may be cloud-based or edge-based. This continuous monitoring allows system 100 to identify changes in the state of the object 140, such as scratches on an object 140, dropped objects 140.2, objects 140.4 causing an unbalanced load or even the potential loss of components from a tracked object 140.2. In addition, the system 100 considers factors such as delivery delays as part of this state assessment.

When the system 100 detects problems such as a dropped component, load imbalance, or other indicators of a potential deterioration in the state of the object 140, it may initiate corrective actions by issuing specific commands that are communicated to the transport cobot 110 responsible for transporting the object 140 or other relevant cobots 120 within the environment. These corrective actions may include adjusting the route of the transport cobot 110 or imposing restrictions on certain movements. The purpose of these commands is to improve the state of the object 140 and proactively prevent potential damage or delays that may result in a degradation of their states. Alternatively or additionally, as a final step, this system 100 may notify human personnel, such as by audio signals or text messages.

The term “state” can be equivalently described as “condition.” Further, the term “cobot” may be used interchangeably with “robot” or “autonomous actor.” Further, the term “actor” can be either an autonomous actor or a human actor.

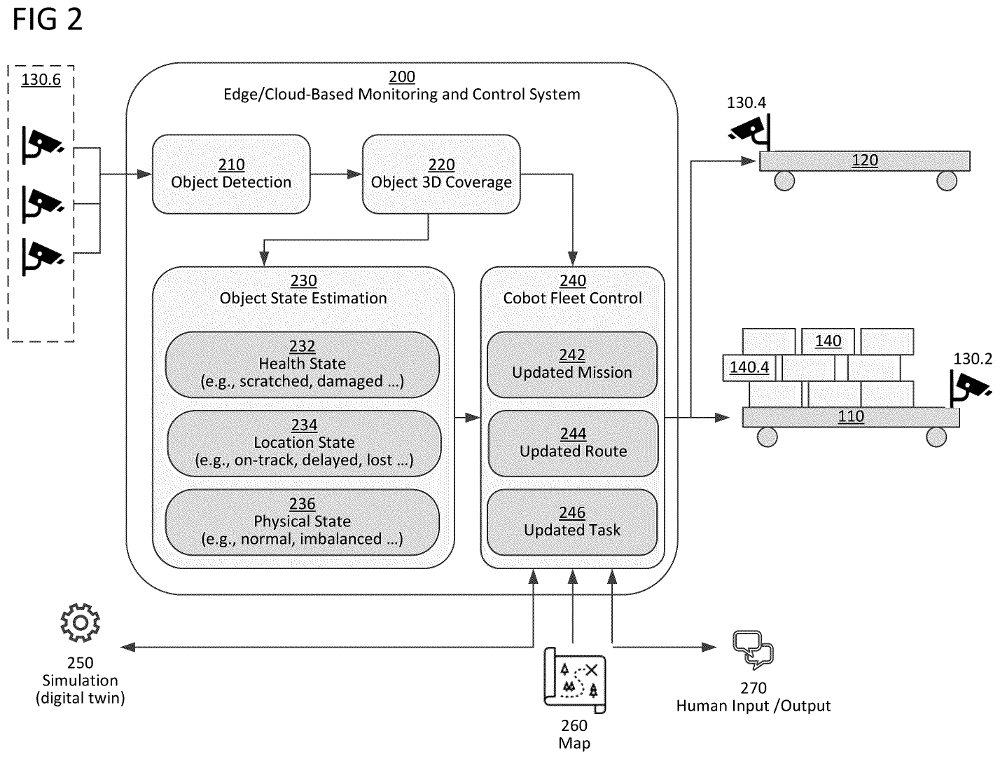

FIG. 2 illustrates a schematic diagram of an edge-based or cloud-based monitoring and control system 200, in accordance with aspects of the disclosure.

The monitoring and control system 200 comprises object detection module 210, object three-dimensional coverage module 220, object state estimation module 230, and cobot fleet control module 240.

The term “module” is for ease of explanation regarding the functional association between hardware and software components. Alternative terms may include “engine,” “processor circuitry,” or the like.

Object Detection Module 210

The object detection module 210 (or object detection processor circuitry 210) is operable to optionally use available sensor data, not limited to a single transport cobot 110, 120, to perform object detection. This can be accomplished based on a digital twin of the warehouse (if one exists) or using any known object detection and classification methods, such as convolutional neural networks (CNNs), a clustering solution, deep learning transformational networks, or the like. The result is a list of relevant objects 140, potentially excluding humans not being of interest. These identified objects 140 may be characterized by a number of attributes, including their location, dimensions (length, width, height), surface material (e.g., plastic film), and other relevant properties.

Object Three-Dimensional Coverage Module 220

The object three-dimensional coverage module 220 (or object coverage processor circuitry 220) performs a three-dimensional coverage analysis on the detected object 140, with the goal of maintaining an updated three-dimensional model of each object 140 based on the sensor data. This analysis accounts for potential changes in the shape of an object 140, such as due to scratches, by verifying the age of the information using sensor time stamps.

After determining that the sensor data is outdated based on timestamp information associated with the sensor data, the object three-dimensional coverage module 220 discards and/or updates the sensor data. The object state estimation module 230 proactively requests an update for that particular object 140. In such cases, the object three-dimensional coverage module 220 may transmit a sensor data request to the cobot fleet control processor module 240, which is authorized to generate a command to either the transport cobot 110, another cobot 120, or another actor to change its action to capture updated or additional sensor data related to the state of the object 140. This may include rerouting the transport cobot 110, adjusting its speed to synchronize with other cobots 120, and more, in an effort to generate more recent or additional sensor data.

To illustrate this process, consider a scenario in which an object 140 currently being transported by transport cobot 110 is not fully perceived from one side. The object three-dimensional coverage module 220 detects this problem and sends a request to the cobot fleet control module 240. The cobot fleet control module 240 determines that cobot 120 is in the vicinity and that updating the route for cobot 120 would not significantly increase operating costs. As a result, a new route is sent to cobot 120, which subsequently passes transport cobot 110. Cobot 120's sensors 130.4 capture the relevant side of the object on transport cobot 110 and provide the necessary data to the object three-dimensional coverage module 220.

There are existing approaches for identifying missing data to create a complete three-dimensional representation of an object 140. However, this disclosure additionally takes into account the age of the information, allowing not only the creation of a complete three-dimensional representation but also the discarding of outdated information. In addition, a three-dimensional representation need not necessarily refer exclusively to a three-dimensional mesh; it could alternatively or additionally include a collection of images taken from sides of an object 140.

To minimize the data transmission load, only relevant sensor data is transmitted to the edge or cloud system. This is accomplished by informing the relevant sensors 130 of the necessary information, e.g., activating cameras when an object 140 enters the field of view and pre-selecting images based on specific criteria provided with the request.

Object State Estimation Module 230

The object state estimation module 230 (or object state estimation processor circuitry 230) is operable to estimate, based on the sensor data, a prospective probability of a degradation of the state of the object 140 by processing three-dimensional captures of the object 140. The module 230 generates three clusters of information associated with different aspects of the state of the object 140, namely: object health state cluster 232, object location state cluster 234, and object physical state cluster 236. The object health state cluster 232 indicates the health state of the object 140 (e.g., surface scratches, broken, thermal issues, etc.). While the creation of object health state cluster 232 is generally known, this disclosure additionally includes the generation of object location state cluster 234 and object physical state cluster 236.

The object physical state cluster 236, as well as the object location state cluster 234, may have sub-clusters. Within the object physical state cluster 236, sub-clusters may be formed based on the state of the object 140 (e.g., normal, balanced, imbalanced, damaged . . . ) and specific details about its state (e.g., high imbalance, low imbalance, scratches, blue ink marks, water damage, etc.). Meanwhile, the object location state cluster 234 may be divided into sub-clusters depending on whether the object is on track, on time, delayed, off track, and/or lost. For example, the object 140 typically follows path 1 to 3 to 5 to 2 and is expected to reach a particular aisle but deviates from its route and does not reach its intended location, it can be classified as lost and assigned to one or more sub-clusters (e.g., on track, on time, delayed, off track, and/or lost).

To perform these cluster assignments and state estimations, any of various artificial intelligence (AI) algorithms may be applied, such as k-nearest neighbor (KNN), clustering, or deep learning-based approaches for object tracking, defect detection, and object detection.

Further, the object state estimation module 230 may include an interface to a simulation module 250 (or simulation processor circuitry 250) that allows it to perform a simulation on a digital twin of the object 140. These simulations may be used to identify a scenario in which a prospective probability of degradation of the state of the object 140 is greater than a predetermined probability value. Examples of the prospective probability of degradation of the state of the object 140 include the object 140.2 falling or slipping from a particular transport cobot 110, or detecting instances of unbalanced or inadequate loading on the transport cobot 110.

The object state estimation module 230 processes this information to assess the probability of potential degradation in the state of the object 140. This assessment takes into account factors such as the likelihood that damage or delays will occur. This assessment is forward-looking and does not imply that the object 140 has already been damaged or delayed. This forward-looking (predictive) approach allows proactive solutions to be implemented to prevent or mitigate state degradation.

To achieve this, a forward-looking degradation probability P_{D} can be estimated for each cluster or sub-cluster. Each detected degradation can have an individual influence on P_{D}. Therefore, it can be expressed as:

P_{D}=min(1,ΣᵢαᵢFᵢ), (Equation 1)

where i includes influencing aspects, αᵢ represents the weight or scaling factor for respective aspects, and Fᵢ represents the degradation associated with respective aspects. For example, if an object 140 contains ten (10) scratches, individual scratches will be assigned an individual Fᵢ value, but they will have the same weight. Conversely, if a lost object 140 is predicted, it may have a different weight and degradation term. In addition, respective aspects may be associated with a degree of uncertainty. For example, in cases where a scratch cannot be identified with absolute certainty, an uncertainty factor can be taken into account.

Cobot Fleet Control Module 240

The cobot fleet control module 240 (or cobot fleet control processor circuitry 240) is operable to generate a command for either a transport cobot 110 operable to transport the object 140 or another actor (e.g., cobot 120 or human), to take proactive action to mitigate the prospective probability of degradation of the state of the object 140.

The cobot fleet control module 240 is operable to request from the object state estimation module 230 an updated prospective probability of degradation of the state of the object 140. Further, the cobot fleet control module 240 may forward a request to the object state estimation module 230 for additional sensor data regarding the object 140 to reduce uncertainties in incorporating the sensor data updates into the planning cycle. In essence, this is the same as requesting additional sensor data from the object three-dimensional coverage module 220.

Conversely, the object state estimation module 230 may forward a request to the cobot fleet control module 240 to modify the transport cobot 110 or another cobot 120 or a human actor's behavior with respect to the object 140. This modification is intended to proactively prevent potential degradation (e.g., delay) of the state of the object 140, which corresponds to increasing the potential level of acceptance by the eventual recipient of the object 140.

The cobot fleet control module 240 may make adjustments to change routes 244, missions 242, tasks 246, and/or speeds of the transport cobot 110 and/or another cobot 120 to improve the state of the transported object 140 or prevent further degradation. The map 260 of the warehouse provides location information of racks, other objects, entry points, exit points, transfer points, and the like. The cobot fleet control module 240 has access to real-time updates regarding various routes within the warehouse, and may also be responsive to voice prompts. For example, if object state estimation module 230 detects a significant imbalance in the load being carried by a transport cobot 110, it becomes more important to avoid abrupt maneuvers such as sharp turns, braking, or acceleration by the transport cobot 110. Therefore, this transport cobot 110 may be recommended a new route 244 based on the most current and up-to-date information about available routes within the warehouse, or even a stop at a human inspection/control point. Alternatively, it may be assigned a new task 246, such as using its cobot arm to better balance the load, or a new mission 242, such as traveling to a nearby cobot 120 to facilitate load adjustment.

In addition, the cobot fleet control module 240 may also assign a mission to specific cobots 110, 120 aimed at addressing the root cause of the problem. For example, if a particular type of object 140 consistently sustains similar damage while traversing a particular route, it raises concerns about that route. There may be an obstruction or sharp object that poses a threat to the objects 140 in that area. In such cases, the cobot fleet control module 240 assumes the role of a problem solver and allocates resources to address the problem.

Additionally, when the cobot fleet control module 240 identifies objects 140 with unidentified location states, it may assign a new mission 242 or task 246 to that cobot 110, 120 (or another cobot 110, 120) to retrieve the dropped object 140 from its current location.

The cobot fleet control module 240 is operable to generate an audio or visual notification when the prospective probability of degradation of the state of the object 140 is greater than a predetermined probability value. In addition, the cobot fleet control module 240 parses voice prompts to identify problems and provide guidance for subsequent actions. For example, if audio sensors in a warehouse detect workers discussing a heavy object 140.2 on the floor in aisle 90, the cobot fleet control module 240 can dispatch the cobots 110, 120 with any necessary capabilities to retrieve the object 140.2. It can also respond to on-demand requests from workers who wish to instruct or guide the cobot fleet control module 240 in specific situations.

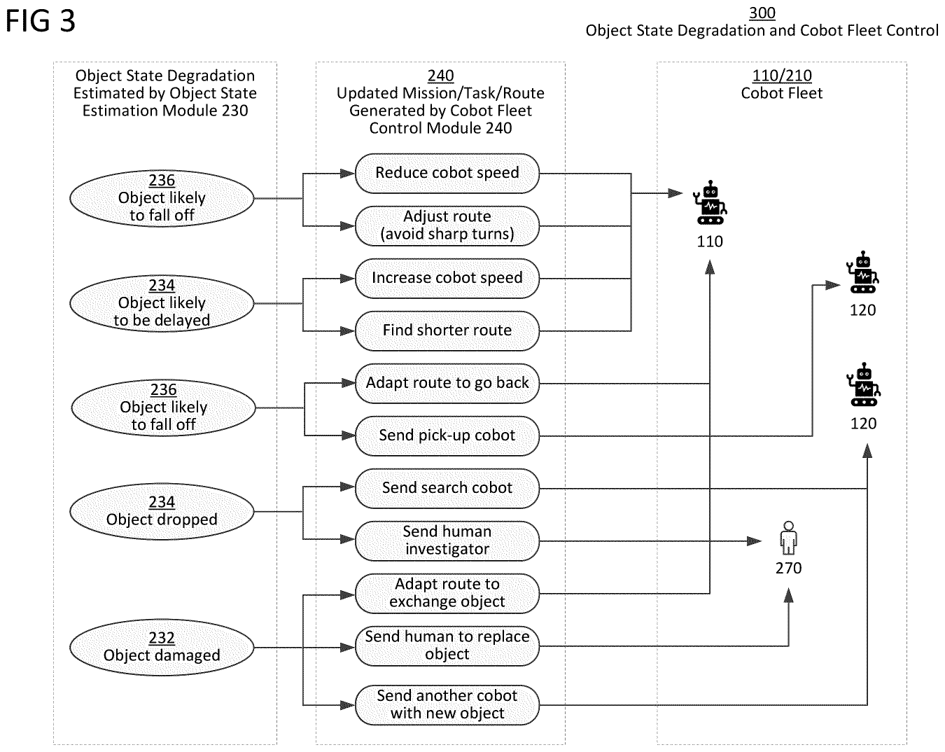

FIG. 3 illustrates a flow diagram 300 of object state degradation and robot fleet control, in accordance with aspects of the disclosure.

When certain types of degradation are detected by the object state estimation module 230, such as an expected object delay, the cobot fleet control module 240 may apply proactive countermeasures or, if the problem already exists, implement measures to minimize its impact. For example, in the case of a reported delay with object 140, the cobot fleet control module 240 may select shorter routes or increase the speed of the cobot 110, 120 to reduce or eliminate the delay.

The cobot fleet control module 240 is a known concept in warehouse operations. However, the present disclosure expands upon existing solutions by incorporating object state awareness and implementing appropriate measures, as described above. The expected result is a reduction in the number of objects 140 that are dropped and a reduction in the amount of damage suffered by objects 140 when route/mission adjustments are made in response to deteriorating object states.

The system 100 can also serve as a means to monitor the operational state of machinery or cobots 110 and 120 and trigger maintenance requests when a deterioration in their state is identified. In addition, the system 100 can enforce parameter limitations such as speed, drivable curves, maximum load capacity, etc.

The disclosed system 100 provides benefits by significantly reducing the likelihood that end customers will miss deliveries or receive damaged objects. In addition, warehouse operations will experience cost savings due to a reduction in lost or damaged objects 140 and the detection of previously unnoticed damage.

FIG. 4 illustrates a block diagram of a computing device 400 in accordance with aspects of the disclosure. The computing device 400 may be identified with a central controller and be implemented as any suitable network infrastructure component, which may be implemented as a cloud/edge network server, controller, computing device, etc. The computing device 400 may serve object three-dimensional coverage module 220, object state estimation module 230, and cobot fleet control module 240 in accordance with the various techniques as discussed herein. To do so, the computing device 400 may include processor circuitry 402, a transceiver 404, communication interface 406, and a memory 408. The components shown in FIG. 4 are provided for ease of explanation, and the computing device 400 may implement additional, less, or alternative components as those shown in FIG. 4.

The processor circuitry 402 may be operable as any suitable number and/or type of computer processors, which may function to control the computing device 400. The processor circuitry 402 may be identified with one or more processors (or suitable portions thereof) implemented by the computing device 400. The processor circuitry 402 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processor circuitry 402 may be operable to carry out instructions to perform arithmetical, logical, and/or input/output (I/O) operations, and/or to control the operation of one or more components of computing device 400 to perform various functions as described herein. The processor circuitry 402 may include one or more microprocessor cores, memory registers, buffers, clocks, etc., and may generate electronic control signals associated with the components of the computing device 400 to control and/or modify the operation of these components. The processor circuitry 402 may communicate with and/or control functions associated with the transceiver 404, the communication interface 406, and/or the memory 408. The processor circuitry 402 may additionally perform various operations to control the communications, communications scheduling, and/or operation of other network infrastructure components that are communicatively coupled to the computing device 400.

The transceiver 404 may be implemented as any suitable number and/or type of components operable to transmit and/or receive data packets and/or wireless signals in accordance with any suitable number and/or type of communication protocols. The transceiver 404 may include any suitable type of components to facilitate this functionality, including components associated with known transceiver, transmitter, and/or receiver operation, configurations, and implementations. Although depicted in FIG. 4 as a transceiver, the transceiver 404 may include any suitable number of transmitters, receivers, or combinations of these that may be integrated into a single transceiver or as multiple transceivers or transceiver modules. The transceiver 404 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 406 may be operable as any suitable number and/or type of components operable to facilitate the transceiver 404 receiving and/or transmitting data and/or signals in accordance with one or more communication protocols, as discussed herein. The communication interface 406 may be implemented as any suitable number and/or type of components that function to interface with the transceiver 404, such as analog-to-digital converters (ADCs), digital to analog converters, intermediate frequency (IF) amplifiers and/or filters, modulators, demodulators, baseband processors, etc. The communication interface 406 may thus work in conjunction with the transceiver 404 and form part of an overall communication circuitry implemented by the computing device 400, which may be implemented via the computing device 400 to transmit commands and/or control signals to execute any of the functions describe herein.

The memory 408 is operable to store data and/or instructions such that, when the instructions are executed by the processor circuitry 402, cause the computing device 400 to perform various functions as described herein. The memory 408 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 408 may be non-removable, removable, or a combination of both. The memory 408 may be implemented as a non-transitory computer readable medium storing one or more executable instructions such as, for example, logic, algorithms, code, etc.

As further discussed below, the instructions, logic, code, etc., stored in the memory 408 are represented by the various modules/engines as shown in FIG. 4. Alternatively, if implemented via hardware, the modules/engines shown in FIG. 4 associated with the memory 408 may include instructions and/or code to facilitate control and/or monitor the operation of such hardware components. In other words, the modules/engines as shown in FIG. 4 are provided for ease of explanation regarding the functional association between hardware and software components. Thus, the processor circuitry 402 may execute the instructions stored in these respective modules/engines in conjunction with one or more hardware components to perform the various functions as discussed herein.

Various aspects described herein may utilize one or more machine learning models for object state estimation 230 and cobot fleet control 230. The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR (light detection and ranging) data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

The techniques of this disclosure may also be described in the following examples.

Example 1. A system, comprising: a communication interface operable to receive sensor data related to a state of an object; object state estimation processor circuitry operable to estimate, based on the sensor data, a prospective probability of a degradation of the state of the object; and cobot fleet control processor circuitry operable to generate a command for either a transport cobot operable to transport the object, or another actor, to take proactive action to mitigate the prospective probability of the degradation of the state of the object.

Example 2. The system of example 1, further comprising: object coverage processor circuitry operable to generate a model of the object based on the sensor data, and to discard and/or update the sensor data after determining, based on timestamp information associated with the sensor data, that the sensor data is outdated.

Example 3. The system of example 2, wherein the object coverage processor circuitry is further operable to transmit a sensor data request to the cobot fleet control processor circuitry to generate a command for either the transport cobot, or the another actor, to change its action to capture updated or additional sensor data related to the state of the object.

Example 4. The system of any of examples 1-3, wherein the proactive action is a change in route, task, mission, or speed of the transport cobot or the another actor.

Example 5. The system of any of examples 1-4, wherein the object state estimation processor circuitry is operable to estimate, based on the sensor data, the prospective probability of the degradation of a physical state of the object.

Example 6. The system of example 5, wherein the physical state of the object comprises information related to whether the object is normal, balanced, unbalanced, or damaged.

Example 7. The system of any of examples 1-6, wherein the object state estimation processor circuitry is operable to estimate, based on the sensor data, the prospective probability of the degradation of a location state of the object.

Example 8. The system of example 7, wherein the location state of the object comprises information related to whether the object is on track, off track, on time, delayed, or lost.

Example 9. The system of any of examples 1-8, further comprising: simulation processor circuitry operable to perform a simulation on a digital twin of the object to identify a scenario having a prospective probability of the degradation of the state of the object being greater than a predetermined probability value.

Example 10. The system of any of examples 1-9, wherein the cobot fleet control processor circuitry is further operable to generate an audio or visual notification when the prospective probability of the degradation of the state of the object is greater than a predetermined probability value.

Example 11. The system of any of examples 1-10, wherein the cobot fleet control processor circuitry is further operable to request an updated prospective probability of the degradation of the state of the object from the object state estimation processor circuitry.

Example 12. The system of any of examples 1-11, wherein the cobot fleet control processor circuitry is operable to generate the command for the transport cobot or another cobot to take the proactive action to mitigate the prospective probability of the degradation of the state of the object.

Example 13. The system of any of examples 1-12, wherein the cobot fleet control processor circuitry is operable to generate the command for a human to take the proactive action to mitigate the prospective probability of the degradation of the state of the object.

Example 14. A component of a system, comprising: processor circuitry; and a non-transitory computer-readable storage medium including instructions that, when executed by the processor circuitry, cause the processor circuitry to: receive sensor data related to a state of an object; estimate, based on the sensor data, a prospective probability of a degradation of the state of the object; and generate a command for either a transport cobot operable to transport the object, or another actor, to take proactive action to mitigate the prospective probability of the degradation of the state of the object.

Example 15. The component of example 14, wherein the instructions further cause the processor circuitry to: generate a model of the object based on the sensor data; and discard and/or update the sensor data after determining, based on timestamp information associated with the sensor data, that the sensor data is outdated.

Example 16. The component of example 15, wherein the instructions further cause the processor circuitry to: generate a command for either the transport cobot, or the another actor, to change its action to capture updated or additional sensor data related to the state of the object.

Example 17. The component of any of examples 14-16, wherein the proactive action is a change in route, task, mission, or speed of the transport cobot or the another actor.

Example 18. The component of any of examples 14-17, wherein the instructions further cause the processor circuitry to: estimate, based on the sensor data, the prospective probability of the degradation of a physical state of the object, wherein the physical state of the object comprises information related to whether the object is normal, balanced, unbalanced, or damaged.

Example 19. The component of any of examples 14-18, wherein the instructions further cause the processor circuitry to: estimate, based on the sensor data, the prospective probability of the degradation of a location state of the object, wherein the location state of the object comprises information related to whether the object is on track, off track, on time, delayed, or lost.

Example 20. The component of any of examples 14-19, wherein the instructions further cause the processor circuitry to: perform a simulation on a digital twin of the object to identify a scenario having a prospective probability of the degradation of the state of the object being greater than a predetermined probability value.

Example 21. A system, comprising: a communication interface means for receiving sensor data related to a state of an object; object state estimation processor circuitry means for estimating, based on the sensor data, a prospective probability of a degradation of the state of the object; and cobot fleet control processor means for generating a command for either a transport cobot operable to transport the object, or another actor, to take proactive action to mitigate the prospective probability of the degradation of the state of the object.

Example 22. The system of example 21, further comprising: object coverage processor circuitry means for generating a model of the object based on the sensor data, and for discarding and/or updating the sensor data after determining, based on timestamp information associated with the sensor data, that the sensor data is outdated.

Example 23. The system of example 22, wherein the object coverage processor circuitry means is further for transmitting a sensor data request to the cobot fleet control processor circuitry to generate a command for either the transport cobot, or the another actor, to change its action to capture updated or additional sensor data related to the state of the object.

Example 24. The system of any of examples 21-23, wherein the proactive action is a change in route, task, mission, or speed of the transport cobot or the another actor.

Example 25. The system of any of examples 21-24, wherein the object state estimation processor circuitry means is for estimating, based on the sensor data, the prospective probability of the degradation of a physical state of the object.

Example 26. The system of example 25, wherein the physical state of the object comprises information related to whether the object is normal, balanced, unbalanced, or damaged.

Example 27. The system of any of examples 21-26, wherein the object state estimation processor circuitry means is for estimating, based on the sensor data, the prospective probability of the degradation of a location state of the object.

Example 28. The system of example 27, wherein the location state of the object comprises information related to whether the object is on track, off track, on time, delayed, or lost.

Example 29. The system of any of examples 21-28, further comprising: simulation processor circuitry means for performing a simulation on a digital twin of the object to identify a scenario having a prospective probability of the degradation of the state of the object being greater than a predetermined probability value.

Example 30. The system of any of examples 21-29, wherein the cobot fleet control processor circuitry means is further for generating an audio or visual notification when the prospective probability of the degradation of the state of the object is greater than a predetermined probability value.

Example 31. The system of any of examples 21-30, wherein the cobot fleet control processor circuitry means is further for requesting an updated prospective probability of the degradation of the state of the object from the object state estimation processor circuitry.

Example 32. The system of any of examples 21-31, wherein the cobot fleet control processor circuitry means is for generating the command for the transport cobot or another cobot to take the proactive action to mitigate the prospective probability of the degradation of the state of the object.

Example 33. The system of any of examples 21-32, wherein the cobot fleet control processor circuitry means is for generating the command for a human to take the proactive action to mitigate the prospective probability of the degradation of the state of the object.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A system, comprising:
a communication interface operable to receive sensor data related to a state of an object;
object state estimation processor circuitry operable to estimate, based on the sensor data, a prospective probability of a degradation of the state of the object; and
cobot fleet control processor circuitry operable to generate a command for either a transport cobot operable to transport the object, or another actor, to take proactive action to mitigate the prospective probability of the degradation of the state of the object.

2. The system of claim 1, further comprising:
object coverage processor circuitry operable to generate a model of the object based on the sensor data, and to discard and/or update the sensor data after determining, based on timestamp information associated with the sensor data, that the sensor data is outdated.

3. The system of claim 2, wherein the object coverage processor circuitry is further operable to transmit a sensor data request to the cobot fleet control processor circuitry to generate a command for either the transport cobot, or the another actor, to change its action to capture updated or additional sensor data related to the state of the object.

4. The system of claim 1, wherein the proactive action is a change in route, task, mission, or speed of the transport cobot or the another actor.

5. The system of claim 1, wherein the object state estimation processor circuitry is operable to estimate, based on the sensor data, the prospective probability of the degradation of a physical state of the object.

6. The system of claim 5, wherein the physical state of the object comprises information related to whether the object is normal, balanced, unbalanced, or damaged.

7. The system of claim 1, wherein the object state estimation processor circuitry is operable to estimate, based on the sensor data, the prospective probability of the degradation of a location state of the object.

8. The system of claim 7, wherein the location state of the object comprises information related to whether the object is on track, off track, on time, delayed, or lost.

9. The system of claim 1, further comprising:
simulation processor circuitry operable to perform a simulation on a digital twin of the object to identify a scenario having a prospective probability of the degradation of the state of the object being greater than a predetermined probability value.

10. The system of claim 1, wherein the cobot fleet control processor circuitry is further operable to generate an audio or visual notification when the prospective probability of the degradation of the state of the object is greater than a predetermined probability value.

11. The system of claim 1, wherein the cobot fleet control processor circuitry is further operable to request an updated prospective probability of the degradation of the state of the object from the object state estimation processor circuitry.

12. The system of claim 1, wherein the cobot fleet control processor circuitry is operable to generate the command for the transport cobot or another cobot to take the proactive action to mitigate the prospective probability of the degradation of the state of the object.

13. The system of claim 1, wherein the cobot fleet control processor circuitry is operable to generate the command for a human to take the proactive action to mitigate the prospective probability of the degradation of the state of the object.

14. A component of a system, comprising:
processor circuitry; and
a non-transitory computer-readable storage medium including instructions that, when executed by the processor circuitry, cause the processor circuitry to:
receive sensor data related to a state of an object;
estimate, based on the sensor data, a prospective probability of a degradation of the state of the object; and
generate a command for either a transport cobot operable to transport the object, or another actor, to take proactive action to mitigate the prospective probability of the degradation of the state of the object.

15. The component of claim 14, wherein the instructions further cause the processor circuitry to:
generate a model of the object based on the sensor data; and
discard and/or update the sensor data after determining, based on timestamp information associated with the sensor data, that the sensor data is outdated.

16. The component of claim 15, wherein the instructions further cause the processor circuitry to:
generate a command for either the transport cobot, or the another actor, to change its action to capture updated or additional sensor data related to the state of the object.

17. The component of claim 14, wherein the proactive action is a change in route, task, mission, or speed of the transport cobot or the another actor.

18. The component of claim 14, wherein the instructions further cause the processor circuitry to:
estimate, based on the sensor data, the prospective probability of the degradation of a physical state of the object,
wherein the physical state of the object comprises information related to whether the object is normal, balanced, unbalanced, or damaged.

19. The component of claim 14, wherein the instructions further cause the processor circuitry to:
estimate, based on the sensor data, the prospective probability of the degradation of a location state of the object,
wherein the location state of the object comprises information related to whether the object is on track, off track, on time, delayed, or lost.

20. The component of claim 14, wherein the instructions further cause the processor circuitry to:
perform a simulation on a digital twin of the object to identify a scenario having a prospective probability of the degradation of the state of the object being greater than a predetermined probability value.
